(19) United States
(12) Patent Application Publication
(10) Pub. No.: US 2009/0110600 A1
(43) Pub. Date: Apr. 30, 2009

(54) METHODS OF OPERATING FILM SURFACE REACTORS AND REACTORS EMPLOYING SUCH METHODS

(76) Inventor: Richard A. HOLL, Camarillo, CA (US)

Correspondence Address: Richard A. HOLL, 7096 Quito Court, Camarillo, CA, 93012, US

(21) Appl. No.: 11/929,888

(22) Filed: Oct. 30, 2007

(51) Int. Cl. B01J 19/00

(52) U.S. Cl. 422/68.1; 422/187

(57) ABSTRACT

In new methods of operating surface reactors, and new reactors employing such methods, the reactor comprises a helical reaction chamber formed as a coil surrounding a tubular support, or a groove machined in a cylindrical body. The passage is supplied with a high velocity flow of air or inert gas constituting a shear transmitting fluid that immediately spreads the reactants, one of which at least must be in liquid state, as they are fed into the chamber against the radially outermost wall of the chamber into a film of thickness not more than 150 micrometers, preferably not more than 120 micrometers, and more preferably less than 100 micrometers. The fluid is supplied at velocities of between 1 and 100 meters per second, preferably between 6 and 20 meters per second. At these speeds and corresponding centrifugal force, molecular clusters, which normally inhibit one on one molecular diffusion reaction between the reactant molecules, are disrupted by the highly sheared fluid to facilitate forced molecular interdiffusion, so that the molecules more aggressively and quickly interact with one another with considerably increased rates of reaction, e.g. 100 to 1,000 times increase. This use of an intermediate shear transmitting fluid traveling at high velocity in a circular path gives flexibility in the radial dimension of the reaction chamber, which can be as large as 10 mm radially and 6 mm longitudinally and provides one open surface of the sheared film of the reagents.

### FIELD OF THE INVENTION

The invention is concerned with new methods of operating surface reactors, and with new reactors employing such methods, and especially to methods and reactors employing gas-shearing of reactant films to facilitate reaction between the reactants.

### BACKGROUND OF THE INVENTION

Frequently it is necessary to conduct a chemical or biochemical reaction in the synthesis of active pharmaceutical ingredients (APIs), intermediates or specialty chemicals by reacting liquid phase reagents with gaseous ones or allowing a gaseous side product of the reaction to be removed very quickly from the reacting liquid phase in order to shift the equilibrium of the reaction such as to increase the formation of the product or the products' selectivity. Such reactions may be carried out in large and expensive autoclave batch reactors or in rotating disk type reactors known by the name “Spinning Disk Reactor,” invented by Prof. Colin Ramshaw, where a liquid reagent mix is forced to flow, starting at the center, radially across a horizontal disk under the force of the centrifugal force thus forming a sheared film, one side of which is exposed to air, a gas or a vapor receiving vacuum. The Ramshaw Spinning Disk Reactor permits the performing of enhanced equilibrium reactions based on the quick removal of unwanted volatile side-products but the reactor's use is limited due to the very short residence time possible and the difficulties encountered when scaling up to industrially attractive production rates.

### SUMMARY OF THE INVENTION

It is an object of this invention to provide new methods of operating reactors and reactors employing such methods which facilitate fast and high rate conversion chemical reactions involving liquid-liquid, solute-liquid, liquid-solid, solute-solid, liquid-gas and solute-gas reactions.

In accordance with the invention there is provided reactor apparatus for reacting together at least two reactants, at least one of which is in liquid state, the apparatus comprising:

a reactor body providing a reaction passage in the form of a helix disposed about a longitudinal axis, the reaction passage having at least one inlet for the reactants at one end and an outlet for reacted and unreacted reactants at the other end;

means for feeding the reactants into the reaction passage inlet, or into respective reaction passage inlets, at a rate such as to establish on the radially outer wall of the reaction passage a film of reactants of radial thickness 150 micrometers or less, preferably 120 micrometers or less, and more preferably 100 micrometers or less;

means for receiving reacted reactants and unreacted reactants form the reaction passage outlet;

means for feeding into the reaction passage ahead of the reaction passage inlet or inlets a pressurized shear transmitting fluid in gaseous state and of corresponding velocity that drags the reactants along the outer wall of the passage under centrifugal force and moves them through the helical reaction passage from the inlet or inlets to the outlet;

and means for separating reacted reactants and unreacted reactants from the shear transmitting fluid upon their discharge from the outlet;

wherein the movement of the shear transmitting fluid and the reactants under drag in the helical path provided by the reaction passage applies corresponding shear to the film sufficient to disrupt molecular clusters therein and thereby facilitate molecular diffusion reaction between the reactants.

Also in accordance with the invention there is provided a method of operating reactor apparatus for reacting together at least two reactants, at least one of which is in liquid state, the reactor apparatus comprising:

a reactor body providing a reactor passage in the form of a helix disposed about a longitudinal axis:

the reaction passage having at least one inlet for the reactants at one end and an outlet for reacted and unreacted reactants at the other end;

means for feeding the reactants into the reaction passage inlet, or into respective reaction passage inlets;

means for receiving reacted reactants and unreacted reactants from the reaction passage outlet;

means for feeding into the reaction passage ahead of the reaction passage inlet or inlets a pressurized shear transmitting fluid in gaseous state that drags the reactants and moves them, subjected to centrifugal pressure, through the helical reaction passage from the inlet or inlets to the outlet while in contact with the radially outer wall of the passage and applying corresponding shear thereto; and

means for separating reacted reactants and unreacted reactants from the shear transmitting fluid upon their discharge from the outlet;

wherein the means for feeding the reactants into the reaction passage inlet, or into respective reaction passage inlets, feeds the reactants therein under centrifugal force at a rate such as to establish a film of the reactants on the radially outer wall of radial thickness 150 micrometers or less, preferably 120 micrometers or less, and more preferably 100 micrometers or less; and

wherein the pressurized shear transmitting fluid is fed into the reaction passage at a rate and of corresponding velocity sufficient to disrupt molecular clusters in the film and thereby facilitate fast molecular inter-diffusion reaction between the reactants.

The shear transmitting fluid separated from the reacted reactants at the outlet may be recycled and fed to the inlet therefor to the reaction passage.

The external radial dimension of the helix may be between 1 cm and 500 cm, preferably between 2 cm and 100 cm, while the radial dimension of the reaction passage may be between 5 mm and 20 mm, preferably between 8 mm and 10 mm, and with a reaction passage of transverse rectangular cross section its longitudinal dimension may be between 3 mm and 20 mm, preferably between 5 mm and 15 mm.

The shear transmitting fluid may be air or an inert gas, and the means for feeding pressurized shear transmitting fluid into the reaction passage may feed it at a velocity between 1 to 100 meters per second, preferably between 6 to 20 meters per second.

Sampling means may be employed for removing samples from the reacting film for determining the stage which the reaction has reached, and a detector may be employed able to examine the film to determine the stage which the reaction has reached. At least one reactant in gaseous state may be delivered into the reaction chamber to be entrained in the shear transmission fluid.

### DESCRIPTION OF THE DRAWINGS

Methods and apparatus that are particular preferred embodiments of the invention will now be described, by way of example, with reference to the accompanying diagrammatic drawings, wherein:

FIG. 1 is an elevation of a complete apparatus system of the invention with the reactor thereof, which is a first embodiment, shown in part longitudinal cross section;

FIG. 2 is a part longitudinal cross section through a reactor which is a second embodiment different from the reactor shown in FIG. 1, but being a cross section taken on the lines D-D in FIG. 1 as though it was this second reactor in the system in place of the first reactor;

FIG. 3 is a longitudinal cross section through part of the reactor of FIG. 1 to show the configuration of the reaction chamber that it provides;

FIG. 4 is a part longitudinal cross section through a reactor which is a further embodiment of the invention, and taken on the lines C-C in FIGS. 5 and 6;

FIG. 5 is a transverse cross section of the embodiment of FIG. 4 taken on the line A-A in FIG. 4; and,

FIG. 6 is a transverse cross section of the embodiment of FIG. 4 taken on the line B-B in FIG. 4.

### DESCRIPTION OF THE INVENTION

The apparatus comprises a cylindrical base member 10 having a longitudinal axis 12 around which is mounted a round transverse cross section helical tube 14 with the helix centered on the axis 12 and extending longitudinally parallel thereto. A helical passage 16 provided by the tube 14 constitutes a reaction chamber 16 and is filled with a shear transmitting fluid, which in this embodiment can be air or, if air is likely to interfere with the reaction, a more inert gas such as nitrogen or argon. This fluid is supplied at high pressure and corresponding high velocity to passage inlet 20 by a gas compressor 22, the pipe through which it passes to the reaction chamber passing through a heat exchanger 24, which cools or heats it as may be required. First and second reactants to be reacted together are fed into the reaction chamber under precise control as to flow via respective precision metering injectors 26 and 28, the entry to the passage being via respective narrow longitudinally extending inlets 30 and 32 downstream of the inlet 20.

The fast moving shear transmitting fluid immediately spreads the reactants over the outermost portion of the cylindrical reactor passage surface 18 under considerable centrifugal pressure in the form of a thin film 34 of radial thickness that is a maximum at its longitudinal center and decreases in both longitudinal directions, its thickness and its longitudinal extent being determined by the rate of flow of the reactants and the radius of the surface 18. The thin film of reacting reactants is immediately subjected to intense shear as it is dragged along the surface by the action of the shear transmitting fluid, the shear being such that molecular clusters within the film are disrupted sufficiently to facilitate reaction between the reactants, accelerating the reaction rate which otherwise would depend on slow, natural, unforced, molecular inter-diffusion, typically increasing such reaction rates by factors of from 100 to 1,000 times, as compared to comparable reactions performed in a conventional stirred tank. Thus, the uniformly interspersed reactants are subjected to intense, forced, molecular inter-diffusion caused by the high shear rates which can be obtained by sufficiently high speed flow. The fact that such high speed, uniform, forced, molecular inter-diffusion of the reactant fluid molecules takes place can be verified by examining various chemical reactions performed in the reactor. Typically the velocity of the shear transmitting fluid is from about 2 to 20 Meters per second, preferably about 6 to 10 meters per second.

In an alternative embodiment illustrated by FIG. 3 the reaction passage 16 is of rectangular transverse cross section so as to have an outermost helical surface, also indicated by reference 18, that extends parallel to the axis 12 and is flat in a plane parallel to that axis. With such a surface configuration the film 34 is of more uniform thickness in the longitudinal direction. The flow of reacted reactants, together with any remaining unreacted reactants exits from the helical reaction passage at outlet 36 and discharges into a separation chamber 38. Typically, within the chamber 38 the flow encounters a deflector plate 40 which directs the liquid output to the bottom of the chamber from which is passes to other apparatus for further processing. The plate performs a separation of the liquid from the shear transmitting fluid which is then recycled via a fluid return outlet pipe 42 to the compressor 22.

It has been found that the thickness of the film 34 formed on the reactor passage wall and subjected to the shear by the shear transmitting fluid is critical for successful facilitation of the required molecular interdiffusion reaction, and a practical upper limit of the thickness is about 150 micrometers. It has been found advantageous to reduce the thickness to a lower value of 120 micrometers, and preferably as low as 100 micrometers. The use of a gaseous fluid as a shear transmitting medium gives a required flexibility as to the radial dimension required for the reaction chamber and this can be as much as 2-500 mm; in this specific embodiment this dimension is 50 mm, while the longitudinal dimension parallel to the axis 12 can be from 30 mm to 500 mm, and in this embodiment is 80 mm.

The external radial dimension of the helical reactor should be such that the shear transmission fluid traveling at a velocity within the specified range can apply shear of the required value to the reacting reactant film, and an appropriate range of values is from 3 cm to 500 cm; in this specific embodiment the radial dimension is 60 mm. The length of the helical passage will be a major factor in determining the residence time of the reacting reactants therein and typically this can be from 5 cm to 500 cm; in this specific embodiment it is 100 cm. It is usually desirable to be able to monitor the progress of a reaction, although this has sometimes been found to be difficult with many reactions using the invention owing the extreme high speeds at which they are completed, and with this embodiment this may be done, for example, by the provision of one or more sampling septa (not shown) in the passage side wall providing the surface 18 spaced along the passage at appropriate intervals. Such septa may be employed to connect any suitable sampling and/or monitoring device to the reaction chamber interior, such as a microliter sampling pipette, which can include a monitor such as a miniature fiber optic spectrometer or infrared detector.

Many different permutations of reactants may be employed as long as at least one of them is in liquid state to permit the formation of the required liquid film on the stator inner wall. For example, one may be a solid material in highly divided form that is injected as a powder or a slurry. Another may be a gas that is entrained in the fluid transmission fluid

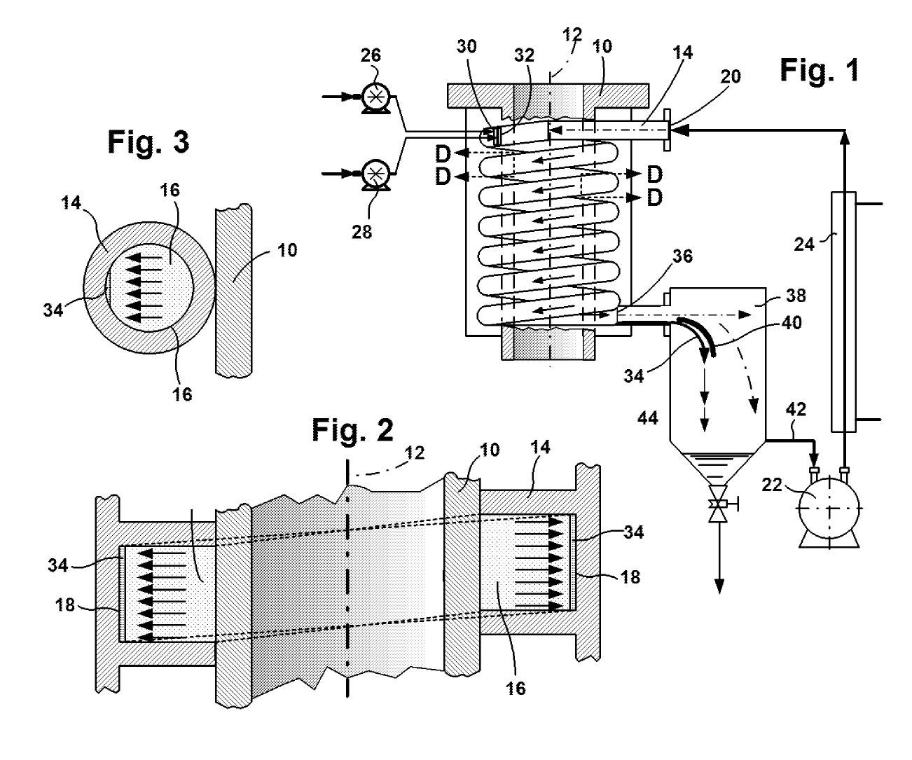

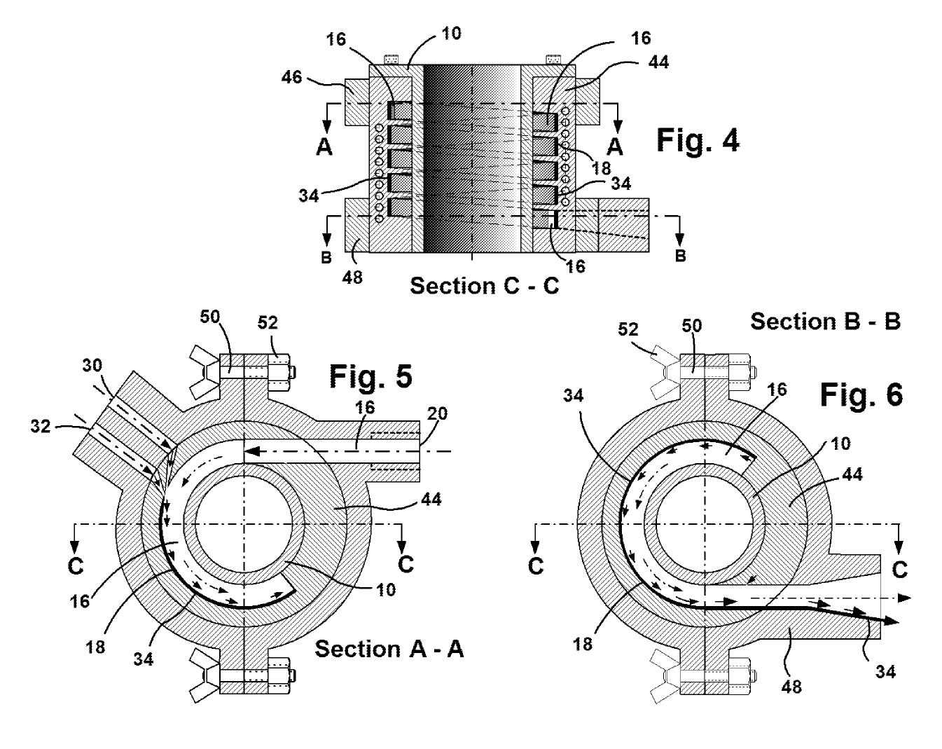

The embodiment of FIGS. 3 through 5 is functionally equivalent to that of FIGS. 1 and 2, but the reactor differs structurally in that the helical reaction passage 16 is formed by machining a helical groove in a cylindrical body 44 which fits tightly around the cylindrical body 10, which thus provides the radially inner wall of the passage. Outer ring shaped bodies 46 and 48 are clamped around the exterior of the body 44, as by bolts 50 and nuts 52, and provide respectively the inlets 30 and 32 for the reactants and the outlet 36 for the reacted reactants. Such a reactor is relatively inexpensive to produce in quantity and is effective for many of the extremely high speed reactions that can be performed using the methods and apparatus of the invention.

It is vitally important in designing processes for the interaction of fluids, and in designing apparatus wherein such processes are to take place, to understand as fully as possible the “mechanics” of the interactions, and this becomes even more important when such interactions are chemical reactions that will result in new products. The following is presented as an abbreviated version of my understanding to date of the mechanics of such interactions, although I do not intend the scope of the invention to be limited in any way by this presentation. A more detailed presentation will be found in my prior U.S. application Ser. No. 10/656,627 (Publication No. 20050053532A1 of Mar. 10, 2005) the disclosure of which is incorporated herein by this reference. It is believed that achievement of fast inter-diffusion is hampered significantly in all chemical reactions by the diffusion retarding preponderance of what have been referred to by a number of different two word terms, the first of which is “molecular” or “cybotactic” and the second of which is “clusters”, or “swarms” or “domains”. Another term sometimes used is pseudo-compounds. For convenience I have adopted the term “molecular clusters” as my preferred reference to these, unless quoting from some pertinent publication. These molecular clusters inherently occur in liquids or gases, within which clusters the molecules are anisotropically ordered from a kinematics point of view. Such ordering impedes rapid, natural interdiffusion due to the oscillation mode of the molecules within the clusters, consisting of large numbers of molecules oscillating in unison and unidirectionally on a scale <100 nm. The problem that arises is to find some way in which practically and economically these molecular clusters can be broken up so as to greatly facilitate un-clustered, individual reactant molecules to encounter each other on a one on one basis and thereby permit very rapid and efficient reactions to take place. The present invention provides such a solution.

Index of Reference Numerals

10. Cylindrical apparatus base member

12. Longitudinal axis

14. Helical tube providing reaction passage

16. Reaction chamber

18. Outermost helical surface of reaction chamber

20. Inlet for shear transmission fluid

22. Gas compressor

24. Heat exchanger for shear transmission fluid

26. Metering injector pump for one reagent together

28. Metering injector pump for another reagent

30. Inlet to reaction chamber for one reagent

32. Inlet to reaction chamber for another reagent

34. Film of reacting reactants

36. Outlet for reacted reactants

38. Separation chamber

40. Deflector plate inside separation chamber

42. Shear transmission fluid return pipe

44. Cylindrical body providing helical reaction chamber

46. Ring shaped body surrounding body 44

48. Ring shaped body surrounding body 44

50. Clamp bolts for bodies 46 and 48

52. Clamp nuts for bodies 46 and 48

I claim

1. A method of operating reactor apparatus for reacting together at least two reactants, at least one of which is in liquid state, the reactor apparatus comprising:
a reactor body providing a reactor passage in the form of a helix disposed about a longitudinal axis:
the reaction passage having at least one inlet for the reactants at one end and an outlet for reacted and unreacted reactants at the other end;
means for feeding the reactants into the reaction passage inlet, or into respective reaction passage inlets;
means for receiving reacted reactants and unreacted reactants from the reaction passage outlet;
means for feeding into the reaction passage ahead of the reaction passage inlet or inlets a pressurized shear transmitting fluid in gaseous state that drags forward the reactants and moves them through the reaction passage from the inlet or inlets to the outlets while in contact with the radially outer wall of the passage and applying corresponding shear thereto; and
means for separating reacted reactants and unreacted reactants from the shear transmitting fluid upon their discharge from the outlet;
wherein the means for feeding the reactants into the reaction passage inlet, or into respective reaction passage inlets, feeds the reactants therein at a rate such as to establish a film of the reactants on the radially outer wall of radial thickness 150 micrometers or less, preferably 120 micrometers or less, and more preferably 100 micrometers or less; and
wherein the pressurized shear transmitting fluid is fed into the reaction passage at a rate and of corresponding velocity sufficient to disrupt molecular clusters in the film and thereby facilitate molecular interdiffusion reaction between the reactants.

2. A method as claimed in claim 1, wherein the shear transmitting fluid separated from the reacted reactants at the outlet is recycled and fed to the inlet therefor to the reaction passage.
The external radial dimension of the helix may be between 1 cm and 500 cm, preferably between 2 cm and 30 cm, while the radial dimension of the reaction passage may be between 5 mm and 20 mm, preferably between 8 mm and 10 mm, and with a reaction passage of transverse rectangular cross section its longitudinal dimension may be between 3 mm and 20 mm, preferably between 5 mm and 15 mm.

3. A method as claimed in claim 1, wherein the external radial dimension of the helix is between 1 cm and 500 cm, preferably between 2 cm and 30 cm.

4. A method as claimed in claim 1, wherein the radial dimension of the reaction passage is between 5 mm and 20 mm, preferably between 8 mm and 10 mm.

5. A method as claimed in claim 1, wherein the reaction passage is of rectangular transverse cross section and its longitudinal dimension is between 3 and 20 mm, preferably between 5 mm and 15 mm.

6. A method as claimed in claim 1, wherein the means for feeding pressurized shear transmitting fluid into the reaction passage feeds it at a velocity between 1 to 100 Meters per second, preferably between 6 to 20 meters per second.

7. A method as claimed in claim 1, wherein the shear transmitting fluid is air or an inert gas.

8. A method as claimed in claim 1, wherein sampling means are employed for removing samples from the reacting film for determining the stage which the reaction has reached.

9. A method as claimed in claim 1, wherein there is employed a detector able to examine the film to determine the stage which the reaction has reached.

10. A method as claimed in claim 1, and comprising means for delivering at least one reactant in gaseous state into the reaction chamber to be entrained in the shear transmission fluid.

11. Reactor apparatus for reacting together at least two reactants, at least one of which is in liquid state, the apparatus comprising:
a reactor body providing a reaction passage in the form of a helix disposed about a longitudinal axis, the reaction passage having at least one inlet for the reactants at one end and an outlet for reacted and unreacted reactants at the other end;
means for feeding the reactants into the reaction passage inlet, or into respective reaction passage inlets, at a rate such as to establish on the radially outer wall of the reaction passage a film of reactants of radial thickness 150 micrometers or less, preferably 120 micrometers or less, and more preferably 100 micrometers or less;
means for receiving reacted reactants and unreacted reactants form the reaction passage outlet;
means for feeding into the reaction passage ahead of the reaction passage inlet or inlets a pressurized shear transmitting fluid in gaseous state and of corresponding velocity that drags forward the reactants and moves them through the reaction passage from the inlet or inlets to the outlet;
and means for separating reacted reactants and unreacted reactants from the shear transmitting fluid upon their discharge from the outlet;
wherein the movement of the shear transmitting fluid and the dragged along reactants in the helical path provided by the reaction passage applies corresponding shear to the film sufficient to disrupt molecular clusters therein and thereby facilitate molecular diffusion reaction between the reactants.

12. Apparatus as claimed in claim 11, and comprising means whereby the shear transmitting fluid separated from the reacted reactants at the outlet is recycled and fed to the inlet therefor to the reaction passage.

13. Apparatus as claimed in claim 11, wherein the external radial dimension of the helix is between 1 cm and 500 cm, preferably between 2 cm and 30 cm.

14. Apparatus as claimed in claim 11, wherein the radial dimension of the reaction passage is between 5 mm and 20 mm, preferably between 8 mm and 10 mm.

15. Apparatus as claimed in claim 11, wherein the reaction passage is of rectangular transverse cross section and its longitudinal dimension is between 3 mm and 20 mm, preferably between 5 mm and 15 mm.

16. Apparatus as claimed in claim 11, wherein the means for feeding pressurized shear transmitting fluid into the reaction passage feeds it at a velocity between 1 to 100 Meters per second, preferably between 6 to 20 meters per second.

17. Apparatus as claimed in claim 11, wherein the shear transmitting fluid is air or an inert gas.

18. Apparatus as claimed in claim 11, and comprising sampling means for removing samples from the reacting film for determining the stage which the reaction has reached.

19. Apparatus as claimed in claim 11, and comprising a detector able to examine the film to determine the stage which the reaction has reached.

20. Apparatus as claimed in claim 20, and comprising means for delivering at least one reactant in gaseous state into the reaction chamber to be entrained in the shear transmission fluid.
